(19) United States
(12) Patent Application Publication
(10) Pub. No.: US 2015/0283789 A1
(43) Pub. Date: Oct. 8, 2015

(54) COMPOSITE MICROSTRUCTURES

(71) Applicant: Dash Robotics, Inc., Berkeley, CA (US)

(72) Inventors: Paul Michael BIRKMEYER, Redwood City, CA (US); Andrew George GILLIES, Berkeley, CA (US); Kevin Charles PETERSON, Mountain View, CA (US); Nicholas Joseph KOHUT, Mountain View, CA (US)

(21) Appl. No.: 14/679,143

(22) Filed: Apr. 6, 2015

Related U.S. Application Data
(60) Provisional application No. 61/976,029, filed on Apr. 7, 2014.

(51) Int. Cl. B32B 7/12; B32B 7/02; B32B 27/34; B32B 38/10; B23K 26/38

(52) U.S. Cl. CPC B32B 7/12; B32B 38/10; B23K 26/38; B32B 27/34; B32B 7/02; B32B 2377/00; B32B 2305/08; B32B 2307/5825

(57) ABSTRACT

Techniques for manufacturing composite microstructures may be realized as a three-dimensional structural component including first and second flat structural regions and a joint region connecting the first and second flat structural regions. The first, second, and joint regions can all include an integral flexible layer comprising a first flexible material that is fiber-reinforced and has a tear resistance greater than 10 N. At least the first and second regions can each include a structural layer comprising a second rigid material having greater stiffness than the first flexible material.

### CROSS REFERENCE TO RELATED APPLICATION

This application claims priority to U.S. Provisional Application No. 61/976,029, filed Apr. 7, 2014, which is incorporated by reference in its entirety as though fully disclosed herein.

### TECHNICAL FIELD

This application relates generally to prototyping and manufacturing, and more specifically to composite materials.

### BACKGROUND

Smart Composite Microstructures (or SCM) is a manufacturing process that was originally developed at UC Berkeley for the construction of robots at the millimeter scale. This process employs two rigid layers and a flexible layer in a laminate structure to form flexure joints, which are frictionless and thus scale well to small structures.

The structure is generally cut using a laser cutter, but many cutting methods could be appropriate. A flat structure is the product, which must be folded into a final three dimensional shape to create a useful device. Older SCM designs are difficult to assemble, due to having small parts, a lack of alignment features, and many parts. Construction often requires specialized tools, such as tweezers, fine knives), and specialized glue.

In the SCM process, a joint is formed in a composite by combining rigid and flexible layers, and selectively cutting away parts of the rigid layer. This is done in a multi-step process, shown below. Existing SCM flexible have been made of mylar (PET), which tears easily and does not last under normal use.

A need therefore exists for an improved material which is more appropriate and resilient under the conditions of SCM manufacture, assembly, and use.

### SUMMARY

In accordance with the disclosed subject matter, systems and methods are described for a manufacture of composite microstructures.

In one embodiment, the techniques may be realized as an apparatus including first and second flat structural regions and a joint region connecting the first and second flat structural regions. The first, second, and joint regions can all include an integral flexible layer comprising a first flexible material that is fiber-reinforced and has a tear resistance greater than 10 N. At least the first and second regions can each include a structural layer comprising a second rigid material having greater stiffness than the first flexible material.

In accordance with other aspects of this embodiment, the joint region may not include a structural layer comprising the second rigid material. The joint region can be configured to be folded such that the first and second flat structural regions are non-coplanar.

In accordance with other aspects of this embodiment, the first and second regions can each include a second rigid layer such that the flexible layer is sandwiched between two rigid layers.

In accordance with other aspects of this embodiment, the two rigid layers for each of the first and second regions can be composed of the same rigid material. The integral flexible layer can adhere to the structural layers of the first and second regions by means of a pressure-activated adhesive.

In accordance with other aspects of this embodiment, the integral flexible layer can adhere to the structural layers of the first and second regions by means of a pressure-activated adhesive.

In accordance with other aspects of this embodiment, the integral flexible layer can adheres to the structural layers of the first and second regions by means of a thermal adhesive.

In accordance with other aspects of this embodiment, the first flexible material can have a thickness of between 15 and 150 microns.

In accordance with other aspects of this embodiment, the first flexible material can have a melting point above 200° C.

In accordance with other aspects of this embodiment, the first flexible material can have an activation energy above 35 mN/m.

In accordance with other aspects of this embodiment, the first flexible material can be ripstop nylon.

In accordance with another embodiment, the techniques may be realized as an process for manufacture including the steps of positioning an integral flexible layer comprising a first flexible material adjacent to an integral structural layer comprising a second rigid material, the first flexible material being fiber reinforced and having a tear resistance greater than 10 N; applying pressure to adhere the integral flexible layer to the integral structural layer; cutting the integral structural layer into first and second structural layers while leaving the integral flexible layer intact, forming first and second structural regions connected by a joint region; and folding the joint region such that the first and second structural regions are non-coplanar.

In accordance with other aspects of this embodiment, the method may further include applying heat to adhere the integral flexible layer to the integral structural layer.

In accordance with other aspects of this embodiment, the method may further include cutting out a three-dimensional structural component from the integral layers, the three-dimensional component including the first and second structural regions and the joint region. In accordance with further aspects of this embodiment, cutting out the three-dimensional structural component can use laser cutting.

In accordance with other aspects of this embodiment, the first flexible material can have a thickness of between 15 and 150 microns.

In accordance with other aspects of this embodiment, wherein the first flexible material can have a melting point above 200° C.

In accordance with other aspects of this embodiment, wherein the first flexible material can have an activation energy above 35 mN/m.

In accordance with other aspects of this embodiment, the first flexible material can be ripstop nylon.

The present disclosure will now be described in more detail with reference to particular embodiments thereof as shown in the accompanying drawings. While the present disclosure is described below with reference to particular embodiments, it should be understood that the present disclosure is not limited thereto. Those of ordinary skill in the art having access to the teachings herein will recognize additional implementations, modifications, and embodiments, as well as other fields of use, which are within the scope of the present disclosure as described herein, and with respect to which the present disclosure may be of significant utility.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 is a cross-sectional view of the flexible and structural layers of a component in accordance with some embodiments.

FIG. 2A illustrates a flat pattern for a three-dimensional component.

FIG. 2B illustrates the three-dimensional component from FIG. 2A, cut and folded according to some embodiments.

FIG. 3A illustrates a flat pattern for a three-dimensional component.

FIG. 3B illustrates the three-dimensional component from FIG. 3A, cut and folded according to some embodiments.

FIG. 4 is a flowchart describing an exemplary manufacturing process according to some embodiments.

FIG. 5A illustrates a flat pattern for two three-dimensional components that fit together.

FIG. 5B illustrates the two three-dimensional components from FIG. 3A, cut and folded and attached according to some embodiments.

FIGS. 6A and 6B show cross-sectional views of the insertion of a fastener to connect two components according to some embodiments.

### DESCRIPTION

In the following description, numerous specific details are set forth regarding the systems and methods of the disclosed subject matter and the environment in which such systems and methods may operate, in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the disclosed subject matter. In addition, it will be understood that the embodiments described below are only examples, and that it is contemplated that there are other systems and methods that are within the scope of the disclosed subject matter.

The invention presented here employs multiple features not previously used in SCM designs to allow easy, rapid folding without the use of specialized tools or adhesives. The invention is an integrated design that includes lap joints, press fits, tabs, and structural spring-loading. These features are designed into the structure of the composite itself, not using common methods as in conventional manufacturing processes, which may also create lap joints and press fits.

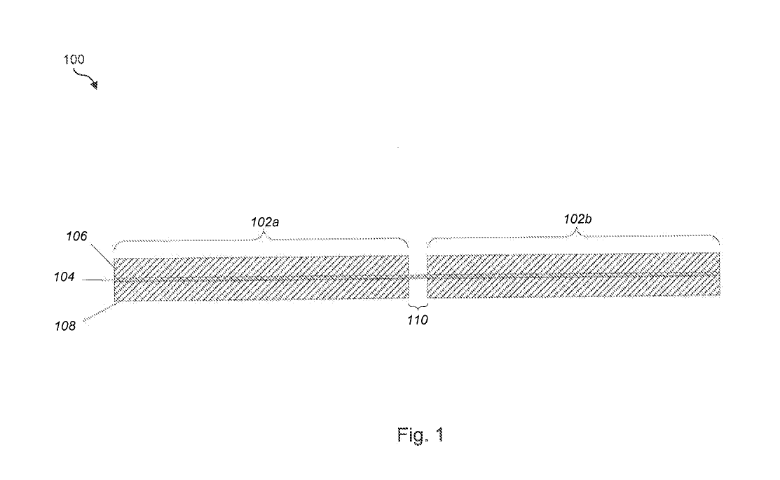

In the SCM process, a joint is formed in a composite by combining rigid and flexible layers, and selectively cutting away parts of the rigid layer (“flexure cuts”). A resulting component 100 having these layers is illustrated in FIG. 1. The component 100 includes first and second structural regions 102a and 102b, each of which is composed of a flexible layer 104 sandwiched between two rigid layers 106, 108. Between the two structural regions is the joint region 110, which includes the flexible layer 104 but not the rigid layers 106, 108. The flexible layer 104 therefore forms a continuous layer of material across all regions of the component 100, while the rigid layers 106 and 108 are removed from the joint region 110 to allow it to act as a flexible joint.

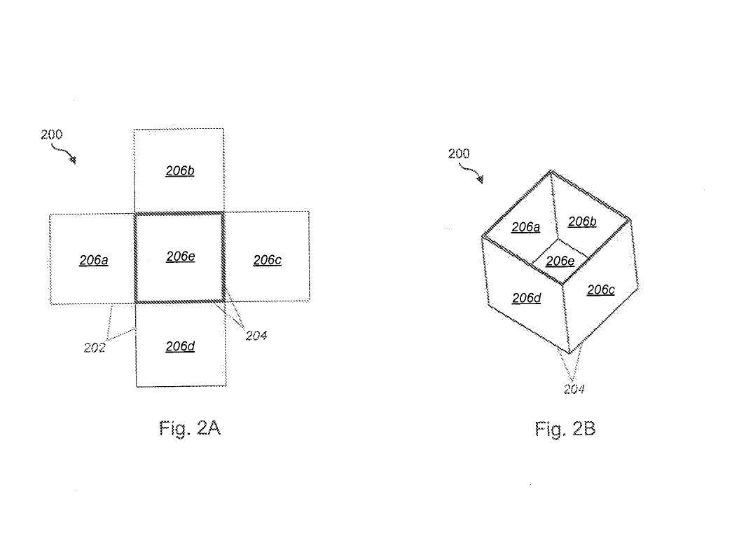

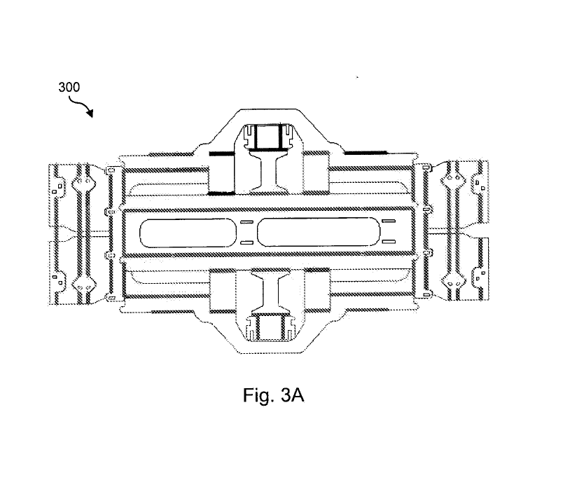

FIGS. 2A and 2B show one example of a simple three-dimensional component 200 in accordance with the invention. The component 200, as illustrated in FIG. 2A, may be cut from a sheet including both rigid and flexible layers. The outer edges 202 represent cuts through all three layers in order to form the pattern of the component 200, while the inner edges 204, shown in bold, are made by removing only the rigid layers as described above with respect to FIG. 1 and joint region 110. These “flexure cuts” result in joint regions 204 where the component 200 can be folded in order to form faces 206a-e oriented in different planar directions, as illustrated in FIG. 2B. By folding the faces 206a-d at the joint regions 204, the component yields a box shape with one open side.

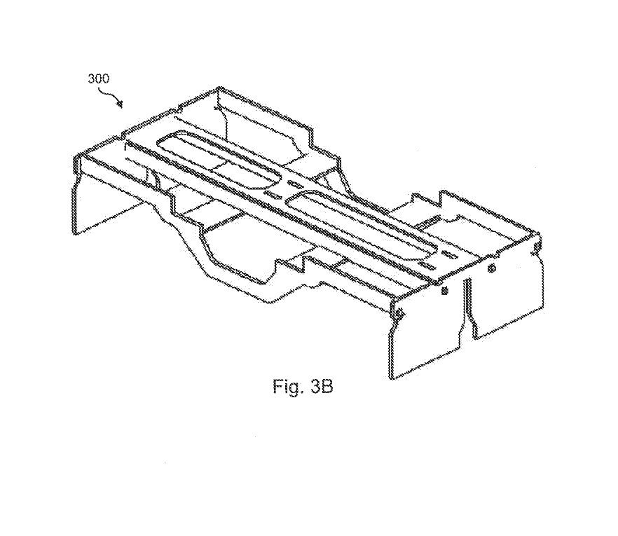

As a further example, FIGS. 3A and 3B illustrate a chassis 300 for a microrobot which is, again, cut from a sheet having multiple layers with full outline cuts and internal flexture cuts as shown in regular and bold lines, respectively, in FIG. 3A. Once the pattern is cut from the sheet, the component 300 can be folded at the joint regions to form the three-dimensional chassis shape as shown in FIG. 3B. Other components can be cut and added to the chassis using the same technique.

Manufacturing the component may involve the application of a thermal adhesive and one or more lamination steps, including the application of pressure and/or heat to the layers such that they properly adhere. The particulars of the lamination process may depend on the materials as further explained below.

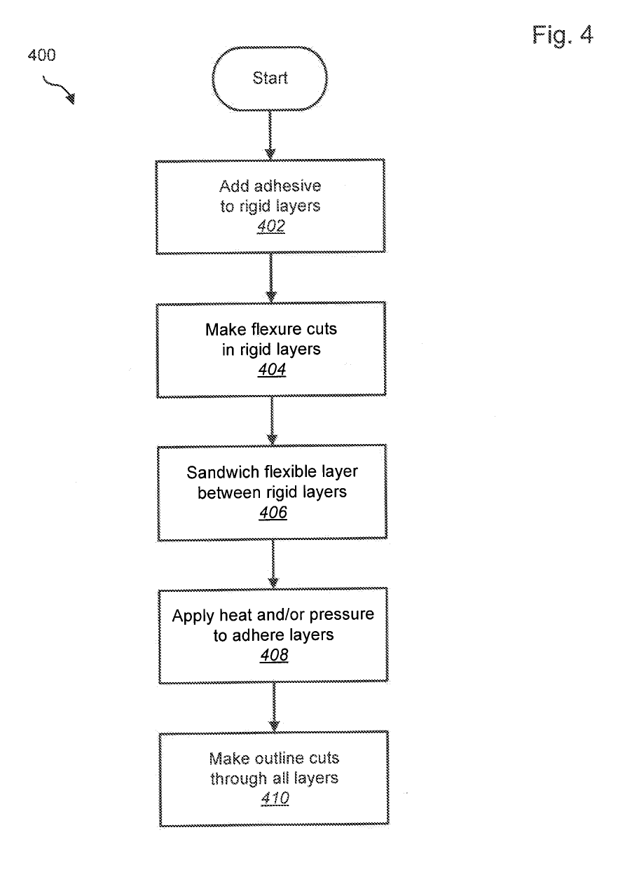

An example process 400 for manufacturing a component in accordance with embodiments of the present invention is illustrated by the flowchart of FIG. 4. One of ordinary skill in the art will recognize that this manufacturing process is exemplary and that some variation in the method will be known to yield similar results.

To begin the manufacturing process, adhesive is added to each rigid layer (402). The adhesive may be selected for its bonding properties for the materials used for the rigid and flexible layers, as further outlined below. The adhesive may be pressure and/or heat sensitive; correspondingly, heat and/or pressure may be applied to each rigid layer in order to apply the adhesive. In some implementations, a particular amount of time is based to allow the adhesive to wet each rigid layer, but not so much time that the adhesive dries before the addition of the flexible layer as described below.

Flexure cuts are made in each rigid layer (404). These cuts may be made, for example, by the use of a laser cutter or other precision cutting technique. In some implementations, the system may take advantage of the fact that flexure cuts in the two rigid layers will generally be mirror images, as illustrated in FIG. 1. The two layers may therefore, in some implementations, be positioned roughly parallel to each other and a single cut applied across both layers.

The rigid layers, now with flexure cuts, are positioned on either side of the flexible layer (406). Various techniques may be used to assure alignment of the layers such that the flexure cuts are actually mirrored on either side of the flexible layer. In some implementations, machine vision or other techniques may be used to assure precise positioning between layers.

Further heat and/or pressure is applied to the sandwiched layers in order to fully bond the rigid and flexible layers together (408). Various quality control practices may be involved to make sure that the layers fully bond and will not layer delaminate, although the proper selection of materials (as further described below) should help to reduce such defects.

Once the layers are bonded together, the outline cuts are made through all three layers (410). This may again be done on a laser cutter or other precision material. This cutting step may again involve aligning the layers according to the position of the flexure cuts so that the outline and flexure cuts create the appropriate shapes in the resulting component.

Efficient manufacturing and handling of these components require careful selection of materials for the flexible and rigid layers. Because the component joints include the flexible layer alone, this layer must be selected not only for flexibility, but for strength and durability as well. SCMs have customarily used sheets made from polyethylene terephthalate resin (“PET”). While adequate in certain respects, PET fails to meet the materials criteria for the present invention as explained below.

Tear strength. The flexible layer material needs to have sufficiently high tear strength to resist tearing at the joints, which are put under stress when the mechanism operates. In order to reliably operate without tearing during regular use, the flexible material used in the components should generally be able to withstand upwards of 10 N of force before tearing. A material with a tear resistance above 10 N will withstand normal handling and operation. If the flexible material has a tear resistance significantly below 10 N, the chances of tearing during normal assembly and use rises greatly.

A standard sheet of PET resin of 2 mil thickness has a tear resistance on the order of 0.3 to 0.5 N. This is well below the desired threshold, and represents a significant likelihood of tearing during use. In contrast, a sheet of ripstop nylon easily withstands 30 N or more of force before tearing. Thus, fiber-reinforced thermoplastic such as ripstop nylon is greatly preferred over traditional materials for resilience in assembly and handling.

Thickness. The thickness of the flexible layer greatly affects both the bend radius and bending stiffness of the flexible material. Ideally the thickness should allow for a characteristic “springiness” in the joint regions such that the pieces can be bent into their three-dimensional configuration and then remain in that shape thereafter.

If the bend radius is too high, then the mechanism will not fold properly into its intended three-dimensional shape. Further, for systems that are mechanically actuated (such as microrobots), an excessive stiffness in the joints due to and overly thick flexible layer may reduce movement efficiency and require excessive energy output in order to operate.

On the other hand, a thickness below the effective range may be too yielding and not hold shape nor provide sufficient resistance to movement for sufficient structural support to the three-dimensional components. A thickness on the order of 15 to 150 microns provides the appropriate flexibility and resilience.

Various fiber-reduced thermoplastics, most notably ripstop nylon, are provided in the 25-100 micron thickness range. These thermoplastics are therefore acceptable with respect to their thickness as candidates for the flexible layer material.

Melting temperature. During initial manufacture of the three-dimensional component, heat is often applied to laminate the layers together. Further, laser cutting is often the preferred method for making the outline cuts to separate the component die from the fabric sheet. During both these procedures, it is greatly preferred that the layer materials have melting temperatures in excess of 200° C. so as not to deform during lamination and cutting. Both customarily-used PET and certain fiber-reinforced thermoplastics, such as ripstop nylon, have melting points between 250° C. and 275° C., and so are therefore appropriate candidates for the flexible material based on this measure.

Adhesion/surface energy. The flexible material must have sufficient surface energy such that the adhesive can properly bond the flexible layer to the rigid layers during lamination. Insufficient adhesion can result in delamination, either during the initial manufacturing process or later during handling. Surface energy at or above 35 mN/m is sufficient for the bonding agents most typically used. Both PET and ripstop nylon have surface energies measured in excess of 40 mN/m and so bond adequately under manufacturing conditions to avoid delamination.

Table I below shows the comparison of four materials based on the properties noted above: basic extruded polyethylene terephthalate resin sheet (“PET”), ripstop nylon, spunbond polyolefin fiber (trade name TYVEK™) and fiber-reinforced woven polyester fabric (trade name DACRON™). One of ordinary skill the art will recognize that other materials could be evaluated on this same basis.

TABLE I
Evaluation of Materials

| Criterion | PET | Ripstop Nylon | Tyvek | Ripstop Dacron |
|---|---|---|---|---|
| Tear strength | No | Yes | No | Yes |
| >10 N | (0.3 to 0.5 N) | (30 N) | (5 N) | (25 N) |
| Thickness | Yes | Yes | No | Yes |
| 15-150 μm | (25-50 μm) | (25-100 μm) | (200-225 μm) | (30-100 μm) |
| Melts | Yes | Yes | No | Yes |
| above 200° C. | (254° C.) | (260° C.) | (135° C.) | (250° C.) |
| Adhesion | Yes | Yes | No | Yes |
| >35 mN/m | (42 mN/m) | (42-50 mN/m) | (33 mN/m) | (40-50 mN/m) |

From the above table, PET is not tear resistant enough, and Tyvek is wholly unsuited. Ripstop nylon matches all four criteria, and is therefore an example of an appropriate material for use in the flexible layer of the components. Ripstop Dacron, which is woven rather than extruded plastic, also matches all four criteria and would therefore be suitable as the material for the flexible layer.

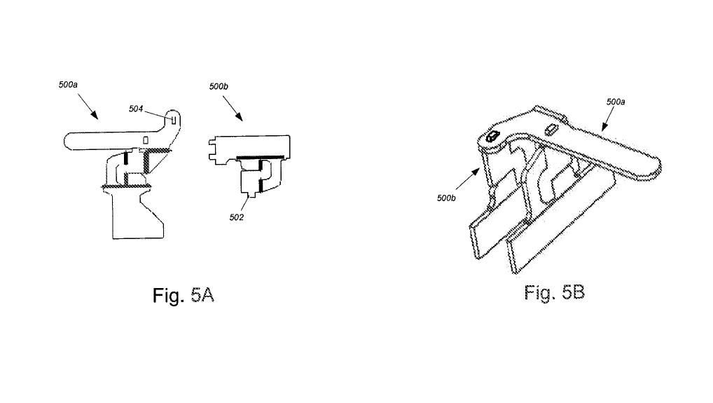

The increased resilience and durability of components using materials meeting the above criteria allows for three-dimensional components to be attached together in a variety of ways. In some implementations, components are joined together by means of tab-and-slot connectivity between pieces, the resilient joint allowing for these pieces to be securely joined together by hand. FIGS. 5A and 5B illustrate two components 500a,500b which, when folded, can fit together by means of tabs 502 fitting into cut slots 504. FIG. 5B illustrates the two components attached together.

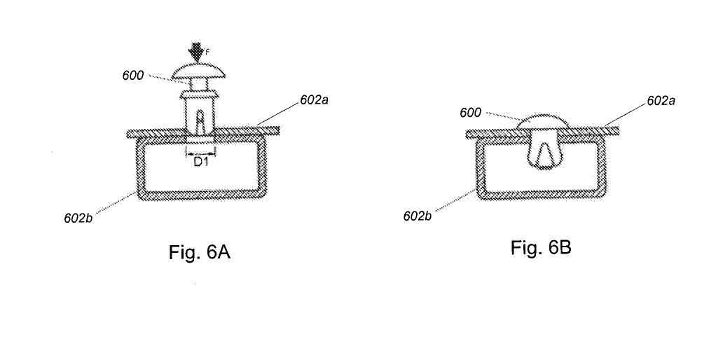

In addition to using the properties of the components themselves to allow for integral attachment of pieces, fasteners may also be added in some cases. SCM customarily used glue to attach pieces, but this solution is imprecise and tends to wear quickly with normal use. A superior method is to use hard fasteners such as the plastic rivets 600 shown in FIGS. 6A and 6B. What are depicted are button-type rivets 600, which are designed to be deployed by applying a downward force F onto the head as shown in FIG. 6A. The rivets 600 provide a secure, permanent connection when placed. As illustrated in FIG. 6A, a rivet 600 can connect a first component 602a to a second component 602b by placement in a hole of proper diameter (the necessary diameter D1 of the hole will depend on the size of the rivet 600). The rivets 600 can be constructed of any appropriate lightweight material, such as aluminum or thermoplastic.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

What is claimed is:

1. A three-dimensional structural component, comprising first and second flat structural regions and a joint region connecting the first and second flat structural regions;
wherein the first, second, and joint regions all include an integral flexible layer comprising a first flexible material, the first flexible material being fiber-reinforced and having a tear resistance greater than 10 N; and
wherein at least the first and second regions each include a structural layer comprising a second rigid material having greater stiffness than the first flexible material.

2. The component of claim 1,
wherein the joint region does not include a structural layer comprising the second rigid material, and
wherein the joint region is configured to be folded such that the first and second flat structural regions are non-coplanar.

3. The component of claim 1, wherein each of the first and second regions each include a second rigid layer such that the flexible layer is sandwiched between two rigid layers.

4. The component of claim 1, wherein the two rigid layers for each of the first and second regions are composed of the same rigid material.

5. The component of claim 1, wherein the integral flexible layer adheres to the structural layers of the first and second regions by means of a pressure-activated adhesive.

6. The component of claim 1, wherein the integral flexible layer adheres to the structural layers of the first and second regions by means of a thermal adhesive.

7. The component of claim 1, wherein the first flexible material has a thickness of between 15 and 150 microns.

8. The component of claim 1, wherein the first flexible material has a melting point above 200° C.

9. The component of claim 1, wherein the first flexible material has an activation energy above 35 mN/m.

10. The component of claim 1, wherein the first flexible material is ripstop nylon.

11. A method for manufacturing a three-dimensional structural component, comprising:
positioning an integral flexible layer comprising a first flexible material adjacent to an integral structural layer comprising a second rigid material, the first flexible material being fiber reinforced and having a tear resistance greater than 10 N;
applying pressure to adhere the integral flexible layer to the integral structural layer;
cutting the integral structural layer into first and second structural layers while leaving the integral flexible layer intact, forming first and second structural regions connected by a joint region; and
folding the joint region such that the first and second structural regions are non-coplanar.

12. The method of claim 11,
wherein positioning the flexible layer includes positioning the flexible layer between two integral structural layers; and
wherein applying pressure adheres both of the integral structural layers to either side of the flexible layer.

13. The method of claim 11, further comprising:
applying heat to adhere the integral flexible layer to the integral structural layer.

14. The method of claim 11, further comprising:
cutting out a three-dimensional structural component from the integral layers, the three-dimensional component including the first and second structural regions and the joint region.

15. The method of claim 14, wherein cutting out the three-dimensional structural component uses laser cutting.

16. The method of claim 11, wherein the first flexible material has a thickness of between 15 and 150 microns.

17. The method of claim 11, wherein the first flexible material has a melting point above 200° C.

18. The method of claim 11, wherein the first flexible material has an activation energy above 35 mN/m.

19. The method of claim 11, wherein the first flexible material is ripstop nylon.
